(19) United States
(12) Patent Application Publication
(10) Pub. No.: US 2007/0244588 A1
(43) Pub. Date: Oct. 18, 2007

(54) Method and system for providing controlled release fragrances from substrates and products produced therefrom

(76) Inventor: Denise Taylor, Glendale, NY (US)

Correspondence Address: Mitchell A. Stein, Esq.;STEIN LAW, P.C., Suite 4, 24 Woodbine Avenue, Northport, NY, 11768, US

(21) Appl. No.: 11/404,131

(22) Filed: Apr. 14, 2006

(51) Int. Cl. G06F 19/00

(52) U.S. Cl. 700/97; 700/233

(57) ABSTRACT

A method and system, and the product produced therefrom, for providing a product having at least one controlled release fragrance from at least one substrate, having a user interface for accessing the system, entering selections and viewing a visual display of the product; an image gallery of available images for the substrate; a fragrance gallery of available fragrances to be applied to the substrate for airborne release; a substrate gallery of available materials for the composition of the substrate; a processor for accessing the galleries and determining compatibility based upon a plurality of parameters and the user's selections; and making the product in accordance with the user's selections. The method and system of further has a gallery of compatible product designs. The method and system further has a gallery of compatible product designs that is dynamic and is updated which each use of the method or system. The user may select from the gallery of compatible designs. The parameters include (a) fragrance characteristics; (b) substrate characteristics; (c) appearance of the substrates; (d) expected duration of fragrance release; and (e) expected intensity of fragrance release. The image gallery includes images of landscapes, animals, vehicles and others. The fragrance gallery includes fragrances of fruits, natural materials, perfumes and others.

### FIELD OF THE INVENTION

The present invention relates to the field of fragrances embedded in a controlled-release matrix for airborne release, and more specifically to a method and system for a customer to select from a predetermined gallery of substrate designs and fragrances or to customize a design in a manner that assures that the substrate and fragrance are compatible for a sufficient amount of timed release of the fragrance from the substrate, as well as the product produced therefrom.

### BACKGROUND OF THE INVENTION

In order to cover odors or create a desired fragrance in the environment, many have turned to scented candles, aerosol-canned release mechanisms as well as to thermally produced oil-based plug-in devices and dipped card board hanging devices. The individual is thus limited to the pre-designed fragrances and appearances, with the ability to choose only from that which has already been built and made available to the consumer in a retail establishment.

Dispensers are shown in, for example, U.S. Pat. No. 6,328,287, and gel-foam air fresheners in, for example, U.S. Pat. No. 5,034,222. Yet, heretofore unknown in the art is the ability to determine fragrances and substrates for controlled release in a manner that permits the user to configure the final product without necessarily correlating an odor with a specific design, color or shape, or in any other manner other than as selected by the consumer. Moreover, heretofore unknown is a method and system that determines compatibility between the fragrance embedded in the substrate, meaning that the amount of time that the substrate would release the fragrance can be estimated if not actually determined in advance of the creation of the product, thereby enhancing endurance or minimizing the same. For example, if the product is sought to be used for long period in a room or other location, then the user would choose a fragrance that when embedded in the substrate would have greater longevity of release of the fragrance. If, for example, the user is customizing for a special event, like a party or otherwise, in which an intense quick release is sought, but longevity is not of necessity, then the user can create such devices as well.

It should be recognized that the substrates involved are controlled release matrixes that permit the embedding of the fragrance and the dissipation of the same over time by release from the matrix. Certain of such dissipation curves have greater longevity while others release potently the fragrance over shorter periods of time. The ability to select between these somewhat competitive aspects are objects of the instant invention

Many fragrances are available in the market place, from perfumes to ones that can be synthesized to produce other types of odors all subject to airborne release.

Thus, it is an object of the invention to permit a user to engage a method and system to create from a gallery of images and fragrances specialized fragrance-release substrates in specialized image(s) to suit the specific needs of the individual for specific purposes.

It is yet another object of the invention to customize the images by adding words, phrases, images, logos and the like that are specific and to associate fragrances therewith in a combined product.

Further objects will become apparent to one of ordinary skill in the art upon the understanding of the instant invention.

### SUMMARY OF THE INVENTION

The various features of novelty which characterize the present invention are expressly and unambiguously delineated in the claims annexed to and forming part of the disclosure. For a better understanding of the present invention, its practical advantages, and specific objects attained by its use, reference should be had to the drawings and descriptive matter in which there are illustrated and described preferred embodiments of the invention.

A method and system, and the product produced therefrom, for providing a product having at least one controlled release fragrance from at least one substrate, having a user interface for accessing the system, entering selections and viewing a visual display of the product; an image gallery of available images for the substrate; a fragrance gallery of available fragrances to be applied to the substrate for airborne release; a substrate gallery of available materials for the composition of the substrate; a processor for accessing the galleries and determining compatibility based upon a plurality of parameters and the user's selections; and making the product in accordance with the user's selections. The method and system of further has a gallery of compatible product designs. The method and system further has a gallery of compatible product designs that is dynamic and is updated which each use of the method or system. The user may select from the gallery of compatible designs. The parameters include (a) fragrance characteristics; (b) substrate characteristics; (c) appearance of the substrates; (d) expected duration of fragrance release; and (e) expected intensity of fragrance release. The image gallery includes images of landscapes, animals, vehicles and others. The fragrance gallery includes fragrances of fruits, natural materials, perfumes and others.

Other features will become apparent from reading the disclosure and claims of the instant invention.

### BRIEF DESCRIPTION OF THE DRAWINGS

In the drawings, wherein similar reference characters denote similar elements throughout the several views:

FIG. 1 is a flow chart of the method and system of the preferred embodiment of the subject invention showing the components and various functions;

FIG. 2 is a flow chart of image gallery 10 of the method and system of the preferred embodiment of the subject invention;

FIG. 3 is a flow chart of fragrance gallery 12 of the method and system of the preferred embodiment of the subject invention;

FIG. 4 shows a plurality of examples of images from image gallery 10 of the method and system of the preferred embodiment of the subject invention;

FIG. 5 shows a plurality of other examples of images from image gallery 10 of the method and system of the preferred embodiment of the subject invention;

FIG. 6 shows a plurality of other examples of images from image gallery 10 of the method and system of the preferred embodiment of the subject invention;

FIG. 7 shows a plurality of other examples of images from image gallery 10 of the method and system of the preferred embodiment of the subject invention;

FIG. 8 shows a plurality of other examples of images from image gallery 10 of the method and system of the preferred embodiment of the subject invention; and

FIG. 9 shows a plurality of other examples of images from image gallery 10 of the method and system of the preferred embodiment of the subject invention

### DETAILED DESCRIPTION OF THE PREFERRED EMBODIMENTS

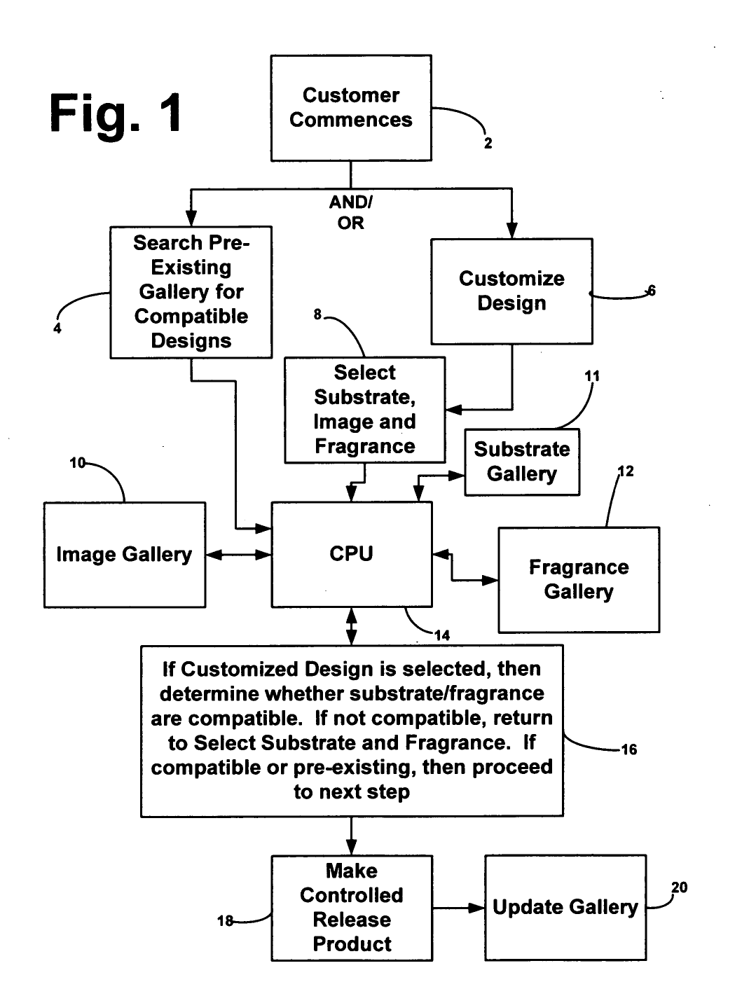

As shown in FIG. 1, customer commences the selection in accordance with the method and system of the subject invention via step 2 by engaging the method and system. At this point, customer may choose to search from pre-existing gallery of compatible designs at step 4 or custom the design via step 6 and the subsequent steps shown thereafter.

In particular, the pre-existing gallery is a non-static library which is continually updated via step 20, and thus shows not only the most popular designs but also those that have already demonstrated compatibility. Thus, the individual can pick quick release of high intensity on various substrates, as well as those of low intensity, as well as those of different odors entirely.

Thus, it should be appreciated that the following parameters are all selectable in combinations by the user for creating a product that emits a fragrance: (a) fragrances; (b) substrates; (c) styles or appearances of the substrates; (d) expected duration of fragrance release; and (e) expected intensity of fragrance release.

Whether the customer engages the pre-existing gallery 4 or customizes the design by commencing at step 8, the control system is provided by CPU 14. “CPU” means central processing unit, and can be any of those known by those of ordinary skill in the art including, without limitation, from small bit processors (like Z-80 or 8 bit devices) to full blown 32 bit or larger processors. In terms of costs and the logic herein, even an EPROM or and E2PROM may satisfy the functions set forth herein. The CPU itself is thus selectable, depending upon the logic necessary to achieve the functions sought by the instant invention.

In the instance in which the customer at step 2 commences and at step 4 selects from the pre-existing gallery, CPU 14 picks from the image gallery 10 and fragrance gallery 12 in accordance with the selection. While step 16 is shown for compatibility it should be appreciated that where a pre-existing gallery item is selected, compatibility is basically established. Yet, the individual may find that upon review of the compatibility one of the foregoing parameters is of greater import than an other, and seek to change the selection. Otherwise, the design is determined, the system generates the product at step 18. Each time a product is generated, the gallery 20 is updated thus showing both the frequency that individuals select particular combinations as well as the available combinations and parameters.

In the instance wherein the customer at step 2 commences and at step 6 selects a customized design, the customer is given the option of selection of substrates, images and fragrances at step 8. As before, CPU 14 provides access to image gallery 10 and fragrance gallery 12. In this instance substrate gallery 11 is also accessed such that the customer can select substrates as well. It should be appreciated that substrates include, without limitation, all forms of controlled release matrixes, including cardboard, paper, stickers, wood, polymeric materials, other plastics, and the like that are functionally determined in the requisite ability to contain fragrances and permit airborne release over time.

After the customer selects substrate, image and fragrance at step 8, CPU 14 accesses galleries 10, 11 and 12, the system determines and presents compatibility at step 16 in accordance with the parameters set forth herein. It should be appreciated that any image can be combined with any fragrance at the customer's selection without any necessary correlation other than the whim or other decision of the customer.

As stated above, if compatibility is determined both by the CPU and the customer via step 16, then the controlled released product is made via step 18 and, as stated, the gallery is updated via step 20.

In this manner, it is thus a feature of the invention to permit a customer to determine substrates, fragrances and images and to create such customized products.

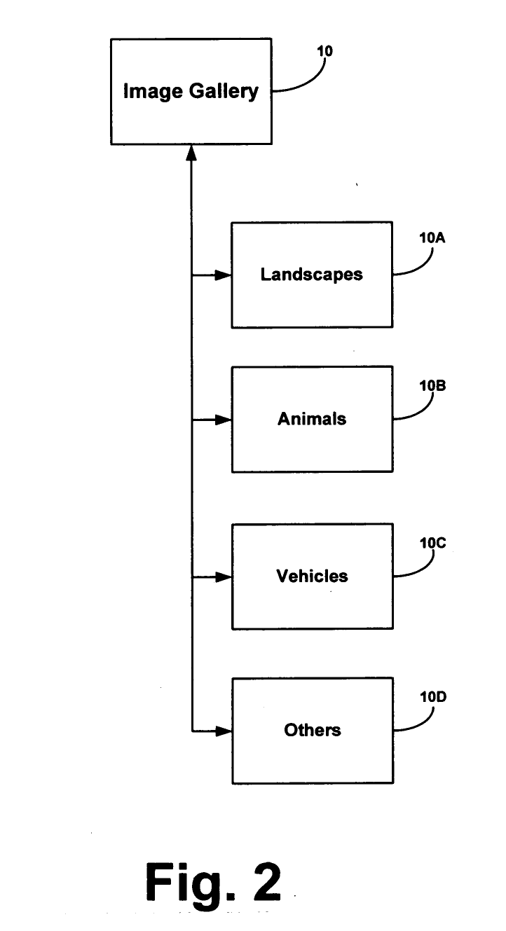

FIG. 2 shows image gallery 10 and a plurality of component themes thereof, including, without limitation, landscapes 10A, animals 10B, vehicles 10C, and other 10D. Image gallery 10 is likely a computer storage device, like a hard drive, although the method and system can also comprise visualizations that may not include typical computer components without deviating from the theme of the instant invention.

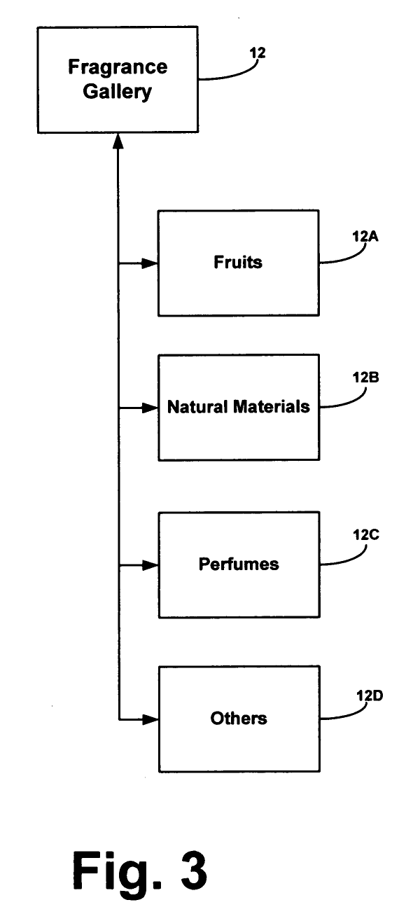

FIG. 3 shows fragrance gallery 12 and a plurality of component themes thereof, including, without limitation fruits 12A, natural materials 12B, perfumes 12C and others 12D. Fragrance gallery 12 likely includes a computer storage device, like a hard drive, although the method and system can also comprise visualizations that may not include typical computer components without deviating from the theme of the instant invention. For example, fragrances may be contained in fragrance dispensing devices such that the individual can smell the fragrance and test those that are more akin to the selection.

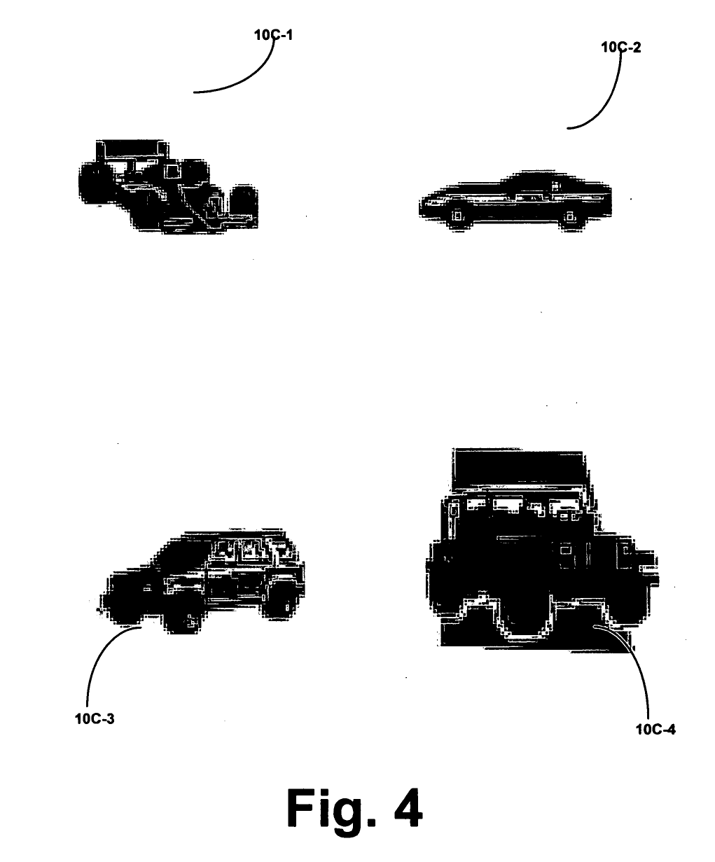

FIG. 4 shows examples of vehicle images 10C (see FIG. 2), in particular, a race car 10C-1, sports car 10C-2, sports utility vehicle 10C-3 and truck vehicle 10C-4.

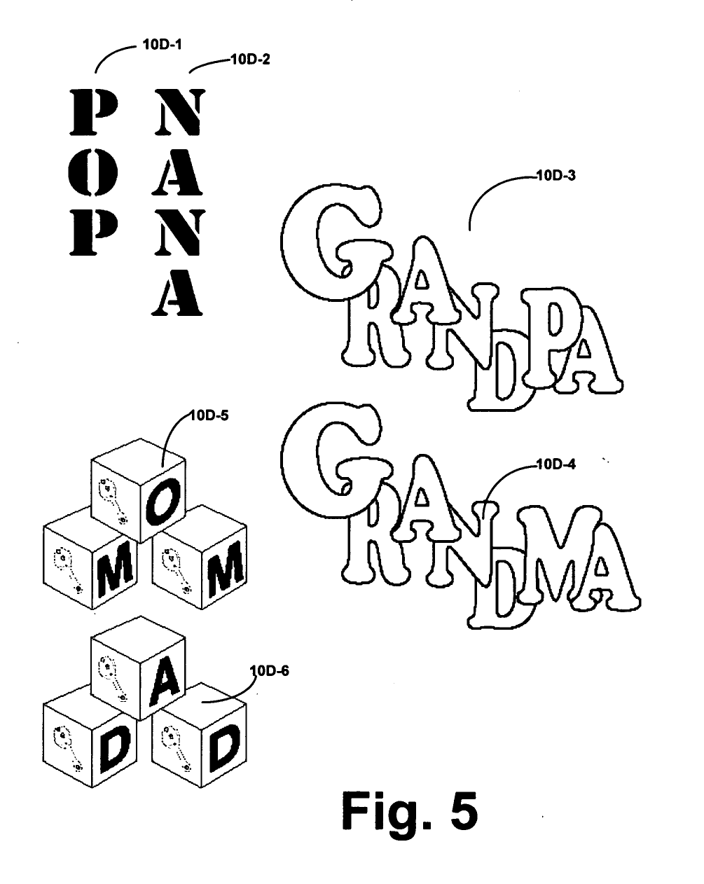

FIG. 5 shows examples of other images 10D (see FIG. 2), in particular, a “POP” sign 10D-1, a “NANA” sign 10D-2, a “Grandpa” sign 10D-3, a “Grandma” sign 10D-4, a “MOM” block design 10D-5 and a “DAD” block design 10D-6. It should appreciated that the designs can be planar or three dimensional. For example, the blocks can be made of wood, or a planar image.

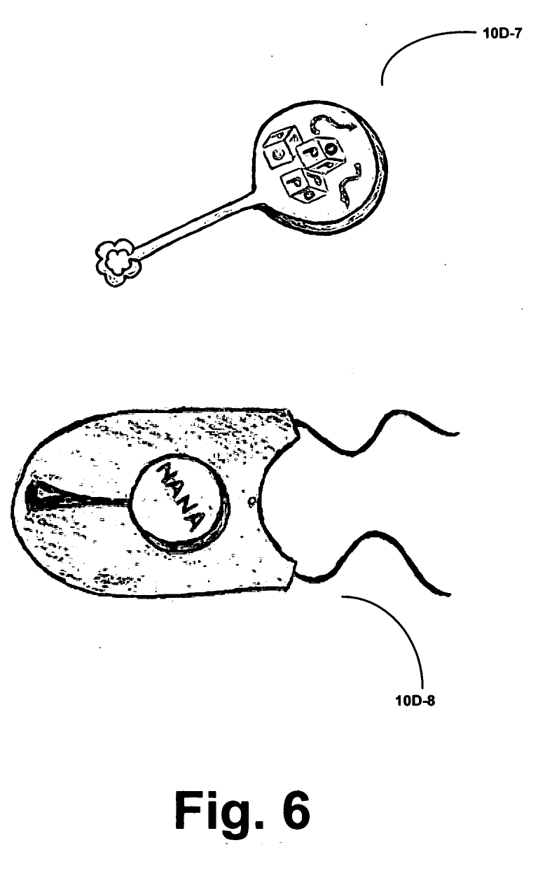

FIG. 6 shows planar or three dimensional designs, in particular rattle 10D-7 and bib 10D-8.

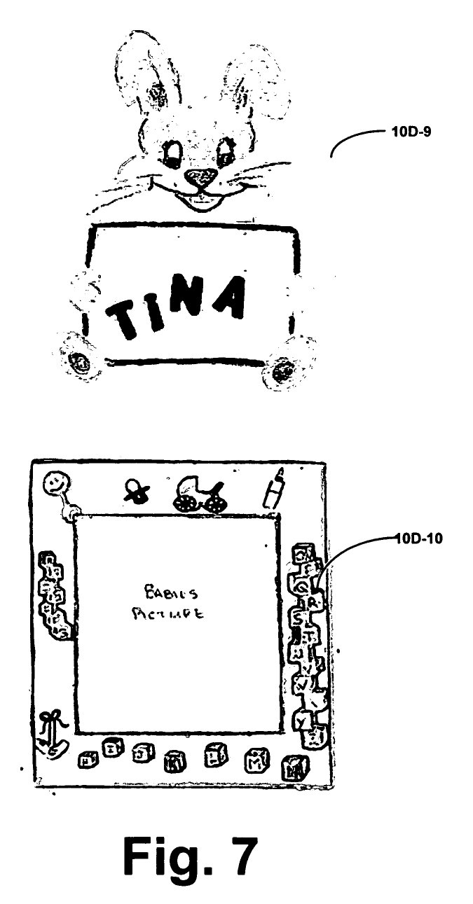

FIG. 7 shows customized images that comprise a multiplicity of potentially differently scented elements combined together, in particular rabbit 10D-9 which permits letters or names as well as the image, and picture frame 10D-10 which includes images of blocks and other items which can be placed in or about the edges of the picture frame which may relate to the picture that the customer can thereafter place therein, subject to the choice of the customer.

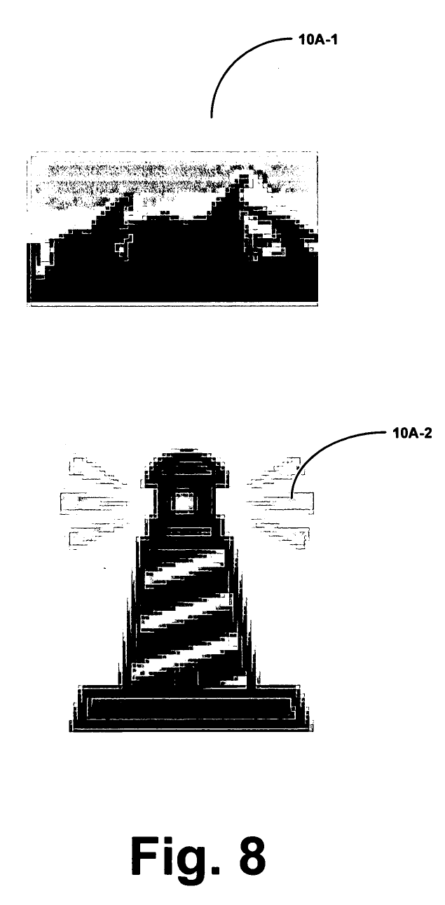

FIG. 8 shows customized images from image gallery 10 (see FIG. 2) specifically in category landscape 10A, and more particularly, but without limitation, a mountain range 10A-1 and a lighthouse 10A-2.

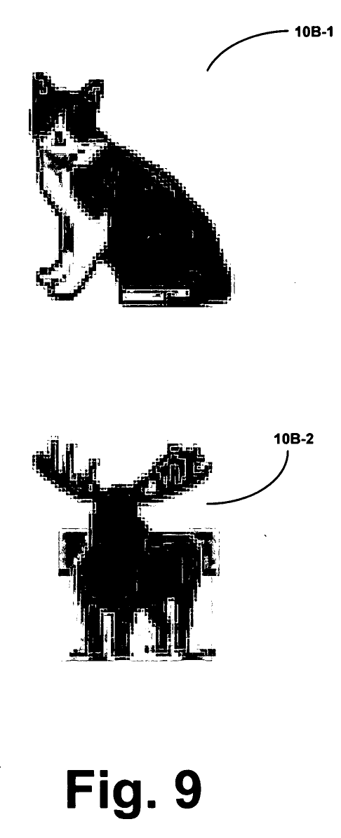

FIG. 9 shows customized images from image gallery 10 (see FIG. 2) specifically in category animals 10B, and more particularly, but without limitation, cat 10B-1, and moose 10B-2.

While there have shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the invention, therefore, to be limited only as indicated by the scope of the claims appended hereto.

I claim:

1. A system for providing a product having at least one controlled release fragrance from at least one substrate, comprising:
(a) user interface means for accessing the system, entering selections and viewing a visual display of the product;
(b) an image gallery of available images for the substrate;
(c) a fragrance gallery of available fragrances to be applied to the substrate for airborne release;
(d) a substrate gallery of available materials for the composition of the substrate;
(e) processing means for accessing the galleries and determining compatibility based upon a plurality of parameters and the user's selections; and
(f) manufacturing means for making the product in accordance with the user's selections.

2. The system of claim 1, wherein the system further comprises a gallery of compatible product designs.

3. The system of claim 2, wherein the gallery of compatible product designs is dynamic and is updated which each use of the system.

4. The system of claim 2, wherein the user may select from the gallery of compatible designs.

5. The system of claim 1, wherein the parameters include (a) fragrance characteristics; (b) substrate characteristics; (c) appearance of the substrates; (d) expected duration of fragrance release; and (e) expected intensity of fragrance release.

6. The system of claim 1, wherein the image gallery includes images of landscapes, animals, vehicles and others.

7. The system of claim 1, wherein the fragrance gallery includes fragrances of fruits, natural materials, perfumes and others.

8. A method for providing a product having at least one controlled release fragrance from at least one substrate, comprising:
(a) accessing the system, entering selections and viewing a visual display of the product;
(b) presenting an image gallery of available images for the substrate;
(c) presenting a fragrance gallery of available fragrances to be applied to the substrate for airborne release;
(d) presenting a substrate gallery of available materials for the composition of the substrate;
(e) processing the galleries and determining compatibility based upon a plurality of parameters and the user's selections; and
(f) manufacturing the product in accordance with the user's selections.

9. The method of claim 8, wherein the method further comprises accessing a gallery of compatible product designs.

10. The method of claim 9, wherein the gallery of compatible product designs is dynamic and is updated which each use of the method.

11. The method of claim 9, wherein the user selects from the gallery of compatible designs.

12. The method of claim 8, wherein the parameters include (a) fragrance characteristics; (b) substrate characteristics; (c) appearance of the substrates; (d) expected duration of fragrance release; and (e) expected intensity of fragrance release.

13. The method of claim 8, wherein the image gallery includes images of landscapes, animals, vehicles and others.

14. The system of claim 8, wherein the fragrance gallery includes fragrances of fruits, natural materials, perfumes and others.

15. The product produced by the method of claim 8.
